(19) United States
(12) Patent Application Publication
(10) Pub. No.: US 2026/0333376 A1
(43) Pub. Date: Oct. 22, 2026

(54) COMMUNICATION METHOD AND CHIP

(71) Applicant: SPREADTRUM COMMUNICATIONS (SHANGHAI) CO., LTD., Shanghai (CN)

(72) Inventors: Huayu ZHOU, Shanghai (CN); Sicong ZHAO, Shanghai (CN); Zhenzhu LEI, Shanghai (CN); Zhengang PAN, Shanghai (CN)

(21) Appl. No.: 19/103,444

(22) PCT Filed: Aug. 11, 2023
(86) PCT No.: PCT/CN2023/112625

§ 371 Date: Feb. 12, 2025

(30) Foreign Application Priority Data
Aug. 12, 2022 (CN) 202210970189.1

(51) Int. Cl. H04W 72/232

(52) U.S. Cl. CPC H04W 72/232

(57) ABSTRACT

The present disclosure discloses a communication method and a chip. The communication method includes the following. Determine to be in a first state during a first time interval according to indication information.

### CROSS-REFERENCE TO RELATED APPLICATION(S)

This application is a National Stage of International Application No. PCT/CN2023/112625, field Aug. 11, 2023, which claims priority to Chinese Patent Application No. 202210970189.1, filed Aug. 12, 2022, the disclosures of which are hereby incorporated by reference in their entirety.

### TECHNICAL FIELD

This disclosure relates to the field of communication, in particular to a communication method, a communication apparatus and a chip.

### BACKGROUND

Currently, in order to save energy, a base station (BS) can be configured to periodically send signals or channels. For example, the BS can periodically send a terminal device a synchronization signal and physical broadcast channel block (SSB), a channel state information-reference signal (CSI-RS), a physical downlink control channel (PDCCH), a semi-persistent-physical downlink shared channel (SPS-PDSCH), etc. In general, the BS can configure connected-mode discontinuous reception (C-DRX), so as to periodically send signals or channels. In other words, when the terminal device is configured with the C-DRX, the terminal device receives the SSB, the CSI-RS, the PDCCH, the SPS-PDSCH, etc., sent from the BS only during an active time. As such, the terminal device is required to monitor during the active time, so as to receive the SSB, the CSI-RS, the PDCCH, the SPS-PDSCH, etc., sent from the BS.

It can be understood that, since the arrival of a data packet is random, the BS may have no data packet to be sent to the terminal device during the active time. In this case, the terminal device still monitors the signals or the channels during the active time, which will increase energy consumption.

### SUMMARY

In a first aspect, a communication method is provided. The communication method includes the following. Determine to be in a first state during a first time interval according to indication information.

In a second aspect, a communication method is provided. The communication method includes the following. Indication information is generated, where the indication information indicates that a terminal device is to be in a first state during a first time interval. The indication information is sent.

In a third aspect, a chip is provided. The chip includes a processor and a communication interface. The processor is configured to cause the chip to perform the method of the first aspect.

### BRIEF DESCRIPTION OF THE DRAWINGS

FIG. 1 is a schematic diagram of a communication system provided in embodiments of the present disclosure.

FIG. 2 is a schematic flowchart of a communication method provided in embodiments of the present disclosure.

FIG. 3 is a schematic structural diagram of a communication apparatus provided in embodiments of the present disclosure.

FIG. 4 is another schematic structural diagram of a communication apparatus provided in embodiments of the present disclosure.

FIG. 5 is yet another schematic structural diagram of a communication apparatus provided in embodiments of the present disclosure.

FIG. 6 is a schematic structural diagram of a module device provided in embodiments of the present disclosure.

### DETAILED DESCRIPTION

The following will clearly and completely describe technical solutions of embodiments of the present disclosure with reference to the accompanying drawings in embodiments of the present disclosure. Apparently, embodiments described herein are merely some embodiments, rather than all embodiments, of the present disclosure. Based on the embodiments of the present disclosure, all other embodiments obtained by those of ordinary skill in the art without creative effort shall fall within the protection scope of the present disclosure.

The terms used in the following embodiments of the present disclosure are merely intended for describing the embodiments, rather than limiting the present disclosure. The singular forms “a”, “an”, “said”, “foregoing”, “the”, and “such” used in the specification and the appended claims are intended for including the plural forms as well, unless specified otherwise in the context. In addition, it can be understood that, the term “and/or” used in the present disclosure refers to and includes any or all possible combinations of one or more of the listed items.

The terms “first”, “second”, “third”, and the like in the specification of embodiments, claims of the present disclosure, and above accompanying drawings are used to distinguish similar objects, and are not necessarily used to describe a particular sequence or order. It can be understood that, the terms thus used may be interchangeable where appropriate, so that the embodiments of the present disclosure described herein, for example, can be implemented in a sequence other than those illustrated or described herein. In addition, the terms “include”, “comprise”, “have”, and variations thereof are intended to cover a non-exclusive inclusion. For example, a process, method, system, product, or server including a series of steps or units is not limited to the listed steps or units, and instead, it can optionally include other steps or units that are not listed or other steps or units inherent to the process, method, product, or device.

In order to better understand embodiments of the present disclosure, a system architecture involved in embodiments of the present disclosure is first described below.

The technical solutions of embodiments of the present disclosure are applicable to various communication systems, for example, a global system of mobile communication (GSM), a code division multiple access (CDMA) system, a wideband code division multiple access (WCDMA) system, a general packet radio service (GPRS) system, a long term evolution (LTE) system, an LTE frequency division duplex (LTE-FDD) system, an LTE time division duplex (LTE-TDD) system, a universal mobile telecommunication system (UMTS), a worldwide interoperability for microwave access (WiMAX) communication system, or a 5th generation (5G) system, a new radio (NR) system, future communication systems, etc.

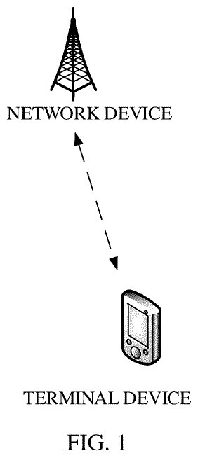

FIG. 1 is a schematic diagram of a communication system provided in embodiments of the present disclosure, and the solutions in the present disclosure are applicable to the communication system. The communication system can include at least one network device and at least one terminal device. FIG. 1 is an example of a communication system including one network device and one terminal device.

### 1. Terminal Device

The terminal device includes a device that provides voice and/or data connectivity for a user. For example, the terminal device in the present disclosure is a device with wireless communication functions. The terminal device can be deployed on land, including indoor or outdoor, handheld, wearable, or in-vehicle. The terminal device can also be deployed on water (such as ships, etc.). The terminal device can also be deployed in the air (such as airplanes, balloons, satellites, etc.). The terminal device can be a mobile phone, a pad, a computer with wireless transceiver functions, a virtual reality (VR) terminal device, an augmented reality (AR) terminal device, a wireless terminal in industrial control, an in-vehicle terminal device, a wireless terminal in self-driving, a wireless terminal in remote medicine, a wireless terminal in smart grid, a wireless terminal in transportation safety, a wireless terminal in smart city, a wireless terminal in smart home, a wearable device, etc. Application scenarios are not limited in embodiments of the present disclosure. The terminal device may sometimes be referred to as a terminal, a user equipment (UE), an access terminal device, an in-vehicle terminal, an industrial control terminal, a UE unit, a UE station, a mobile station, a mobile platform, a remote station, a remote terminal device, a mobile device, a UE terminal device, a wireless communication device, a UE agent, a UE apparatus, etc. The terminal device may also be stationary or mobile. In embodiments of the present disclosure, an apparatus for implementing functions of the terminal device may be a terminal device, or may be an apparatus capable of supporting the terminal device in implementing the functions, such as a chip system or a combined device or component that may implement the functions of the terminal device, which may be installed in the terminal device.

### 2. Network Device

The network device can be a base station (BS), an evolved NodeB (eNodeB), a transmission reception point (TRP), a next generation NodeB (gNB) in a fifth generation (5G) mobile communication system, a next gNB in a sixth generation (6G) mobile communication system, a BS in a future mobile communication system, an access node in a wireless fidelity (Wi-Fi) system. The network device can also be a module or unit that implements some functions of the BS. For example, the network device can be a centralized unit (CU) or a distributed unit (DU). The CU implements functions of a radio resource control (RRC) protocol, functions of a packet data convergence protocol (PDCP), and functions of a service data adaptation protocol (SDAP). The DU implements functions of a radio link control (RLC) layer, functions of a media access control (MAC) layer, and functions of some or all physical (PHY) layers. For specific descriptions of the above protocol layers, reference can be made to related technical specifications of the 3rd generation partnership project (3GPP). The network device may be a macro BS, a micro BS or an indoor station, a relay node or a donor node, etc. In embodiments of the present disclosure, an apparatus for implementing the functions of the network device may be the network device itself, or may be an apparatus capable of supporting the network device in implementing the functions, such as a chip system or a combined device or component that may implement the functions of the network device, which may be installed in the network device.

In order to facilitate understanding of the solutions provided in embodiments of the present disclosure, some terms or related technologies involved in the present disclosure will be introduced first, which are not repeated in the following.

### 1. OnDuration Timer (Also Referred to as “Discontinuous Reception (drx)-on Duration Timer”)

The onDuration timer is introduced to control whether the terminal device receives a physical downlink control channel (PDCCH). An on duration of the onDuration timer is an active time. The active time is a time interval when some timers, such as the onDuration timer, an inactivity timer, etc., are working. The terminal device monitors the PDCCH only during the active time.

In the present disclosure, the on duration can also be considered as “active time”, “wake-up time”, “duration”, etc., which is not limited herein.

Typically, the on duration of the onDuration timer is a short period, such as 8 milliseconds (ms), 10 ms, etc.

### 2. Downlink Control Information (DCI) Format 2_6

In the present disclosure, the DCI format 2_6 and the onDuration timer are associated and have a certain time correlation with each other. For example, there is a configurable time offset between a monitoring window of the DCI format 2_6 and the on duration of the onDuration timer.

### 3. Synchronization Signal and Physical Broadcast Channel Block (SSB)

The SSB can be regarded as a resource for one beam during beam sweeping. Multiple SSBs constitute one SS burst. The SS burst can be regarded as a resource containing multiple beams. Multiple SS bursts constitute one SS burst set. The SSB is repeatedly transmitted on different beams, which is a beam sweeping process. Through training of beam sweeping, the terminal device can sense which beam receives the strongest signal.

The SSB can be used for beam management (BM), time/frequency tracking, mobility management, radio link monitoring (RLM), beam failure detection (BFD), etc.

### 4. Semi-Persistent-Physical Downlink Shared Channel (SPS-PDSCH)

The SPS-PDSCH can be regarded as a semi-statically scheduled PDSCH. The terminal device needs to periodically receive the PDSCH over a period of time.

### 5. Search Space

The search space can include a monitoring occasion (MO), a search space type, an aggregation level (AL), etc., of the PDCCH.

### 6. Channel State Information-Reference Signal (CSI-RS)

The CSI-RS can be used for channel state information (CSI) measurement, the BM, the time/frequency tracking, the mobility management, the RLM, the BFD, etc. A CSI-RS used for the CSI measurement can be referred to as “CSI-RS for CSI”. A CSI-RS used for the BM can be referred to as “CSI-RS for BM”. A CSI-RS used for the time/frequency tracking can be referred to as “tracking reference signal (TRS)”. A CSI-RS used for the mobility management can be referred to as “CSI-RS for mobility”. A CSI-RS used for the RLM can be referred to as “CSI-RS for RLM”. A CSI-RS used for the BFD can be referred to as “CSI-RS for BFD”.

The TRS can be configured through a non-zero power (NZP) CSI-RS resource set parameter. One NZP CSI-RS resource set parameter can contain four NZP CSI-RS resources in two consecutive slots (also referred to as “time slot”), and each slot contains two NZP CSI-RS resources. The TRS can be either periodic or aperiodic. When the TRS is periodic, the CSI-RS resources in the NZP CSI-RS resource set parameter have the same period, bandwidth, and subcarrier location. When the TRS is aperiodic, periodic CSI-RS resources are in one NZP CSI-RS resource set parameter, aperiodic CSI-RS resources are in another NZP CSI-RS resource set parameter, the periodic CSI-RS resources and the aperiodic CSI-RS resources have the same bandwidth (same resource block location), the aperiodic CSI-RS resources are quasi co-location type-A (QCL-Type-A), and the periodic CSI-RS resources are QCL-Type-D.

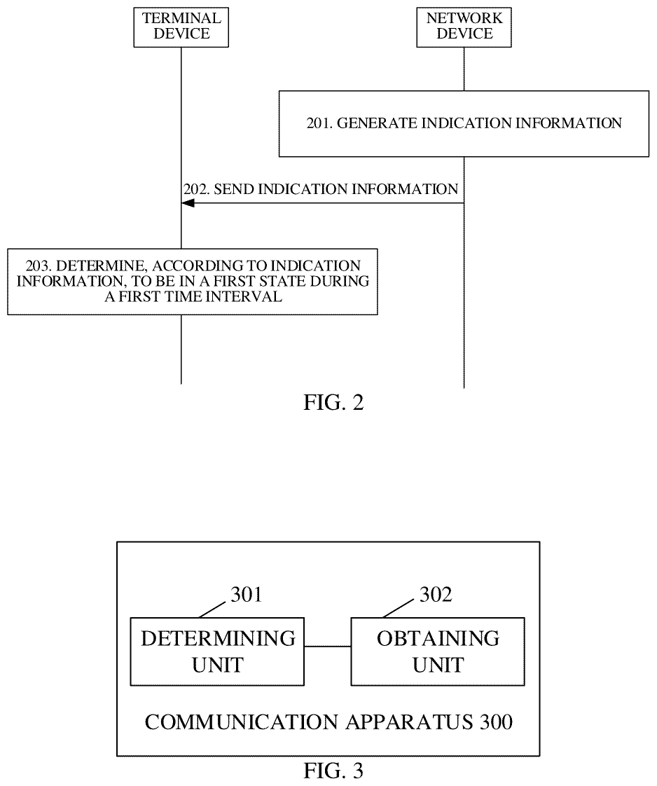

Since the arrival of a data packet is random, the BS may have no data packet to be sent to the terminal device during the active time. In this case, the terminal device still monitors the signals or the channels during the active time, which will increase energy consumption. In order to tackle this problem, reference can be made to FIG. 2. FIG. 2 is a schematic flowchart of a communication method provided in embodiments of the present disclosure. As illustrated in FIG. 2, the communication method includes step 201 to step 203 as follows. The method illustrated in FIG. 2 can be implemented by a terminal device or a network device. Alternatively, the method illustrated in FIG. 2 can be implemented by a chip in the terminal device or a chip in the network device. Exemplarily, the method illustrated in FIG. 2 is implemented by the terminal device and the network device.

Optionally, at step 201, the network device generates indication information.

Optionally, the indication information can indicate at least one of: the terminal device being in a first state during a first time interval, or the network device entering the first state during the first time interval. The first state is, for example, a state in which the network device enters a sleep mode. In the present disclosure, the first state can also be referred to as “sleep state”, “short sleep state”, or “energy-saving state”.

In a first possible implementation, the indication information is carried in a DCI format 2_6. Optionally, the terminal device being in the first state during the first time interval or the network device entering the first state during the first time interval can be understood as at least one of: the terminal device not turning on an onDuration timer, the terminal device not receiving a PDCCH during an on duration of the onDuration timer, or the terminal device not receiving one or more of an SSB, a CSI-RS, and an SPS-PDSCH during the on duration of the onDuration timer.

It can be noted that, in the present disclosure, the DCI format 2_6 and the onDuration timer are associated and have a certain time correlation with each other. For example, there is a configurable time offset between a starting time of an MO of the DCI format 2_6 and a starting time of the onDuration timer. Generally, the terminal device is required to monitor the DCI format 2_6 during the first whole duration (configured through a search space parameter) after the starting time of the MO. The starting time of the MO is before the starting time of the onDuration timer, and a difference between the starting time of the MO and the starting time of the onDuration timer is the time offset.

In a possible implementation, in order to ensure occasions for sending the SSB, the CSI-RS, or the SPS-PDSCH, the network device can reduce a period of the SSB, a period of the CSI-RS, or a period of the SPS-PDSCH (a dense SSB, a dense CSI-RS, or a dense SPS-PDSCH). In this way, the occasions for sending the SSB, the CSI-RS, or the SPS-PDSCH will not be reduced, and a time for the network device to enter the first state can be opportunistically (dynamically) increased, thereby saving energy.

In the case where the indication information is carried in the DCI format 2_6, the indication information can be a wake-up indication.

Optionally, in the case where the indication information is carried in the DCI format 2_6, the first time interval is the on duration of the onDuration timer.

In a second possible implementation, the indication information can be carried in a first DCI format. It can be understood that the DCI format 2_6 is different from the first DCI format. Exemplarily, the first DCI format is a newly defined DCI format.

Optionally, the first DCI format can be configured by the network device in one search space. An AL of the search space can be less than or equal to a preset AL, and an MO of the search space can be denser than that of the DCI format 2_6, such that the network device sending the first DCI format can quickly and frequently enter the first state.

It can be noted that the first DCI format corresponds to a Type3-PDCCH search space set which is a group common (GC) PDCCH that can be configured to a group of terminal devices. The group of terminal devices monitors the same Type3-PDCCH search space. In the case where the indication information can be carried in the first DCI format, the first DCI format can be notified to all terminal devices served by the network device, and thus the first DCI format can be designed and configured to be a DCI format that is uniformly monitored by all the terminal devices. In this way, a total number of bits for the first DCI format can be fewer, e.g., 1 bit, 2 bits, or 3 bits, and fewer ALs are required, thereby reducing resource overhead.

Optionally, in the case where the indication information can be carried in the first DCI format, the first time interval is a preset duration, or the first time interval is a configured duration, such as a duration configured by the network device for the terminal device, or the first time interval is a configured timer, such as a timer configured by the network device for the terminal device, or the first time interval is an on duration of a preset timer, or the first time interval is a duration indicated by a parameter of the preset timer. The preset timer can be different from the onDuration timer. Exemplarily, the preset timer can be a newly defined timer. Certainly, the duration is also different from the on duration of the onDuration timer, and the configured timer can also be different from the onDuration timer.

As can be seen from the above technical solution, decoupling from the on duration of the onDuration timer is realized, thereby improving the system flexibility. Meanwhile, the signaling overhead can be reduced through the preset duration, the on duration of the preset timer, or the duration indicated by the parameter of the preset timer. In addition, one duration or a timer is configured, and thus the duration can be a time that meets current service requirements, thereby improving the system flexibility.

Optionally, in the case where the indication information can be carried in the first DCI format, a starting time of the first state is an M-th slot after a first end symbol, where M is an integer greater than or equal to 1, and the first end symbol is a last symbol of the PDCCH. Alternatively, the starting time of the first state is an N-th slot after a second end symbol, where N is an integer greater than or equal to 1, the second end symbol is a K-th symbol after the last symbol of the PDCCH, and K is an integer greater than or equal to 1. The first DCI format is carried in the PDCCH.

As can be seen from the above technical solution, since the starting time of the first state is the M-th slot after the first end symbol or the N-th slot after the second end symbol, after the terminal device knows, through the PDCCH, that no SSB, CSI-RS, or SPS-PDSCH has been sent, the terminal device can cancel reception of the SSB, the CSI-RS, the SPS-PDSCH, etc., thereby reducing the energy consumption. Secondly, it can also be seen that the starting time of the first state is not a time when the PDCCH is received by the terminal device. As such, the terminal device can have more time to receive the PDCCH, and the network device can have more time to prepare for the transmission of the PDCCH.

Optionally, at step 202, the terminal device obtains the indication information, that is, the terminal device receives the indication information. Correspondingly, the network device sends the indication information.

Optionally, in the case where the indication information can be carried in the first DCI format, operations at step 202 can include the following. The terminal device monitors the first DCI format during the on duration of the onDuration timer.

The first possible implementation and the second possible implementation are applicable to the terminal device, and the indication information can be carried in the DCI format 2_6 and/or the first DCI format.

As can be seen from the above technical solution, the terminal device monitors the first DCI format during the on duration of the onDuration timer, so that the terminal device can determine, according to the indication information, to be in the first state during the first time interval, which means that the terminal device has known that the network device has no data packet to be sent to the terminal device during the active time, and that the terminal device is not required to monitor the CSI-RS, the SSB, the TRS, the SPS-PDSCH, etc., during the first time interval, thereby reducing the energy consumption.

Optionally, for any one of the first possible implementation and the second possible implementation, a terminal device in the first state skips receiving at least one of the following on one or more serving cells: the SSB, the CSI-RS, or the SPS-PDSCH. Alternatively, the terminal device in the first state skips receiving at least one of the following on one or more serving cell sets: the SSB, the CSI-RS, or the SPS-PDSCH.

It can be noted that, in the present disclosure, the terminal device can be configured with one or more serving cells, and multiple serving cells can constitute at least one serving cell set. For example, in a dual connectivity (DC) scenario or a carrier aggregation (CA) scenario, the one or more serving cells can include only a primary cell (PCell) of the terminal device, only a secondary cell (SCell) of the terminal device, or both the PCell of the terminal device and the SCell of the terminal device, which is not limited herein.

In a possible implementation, the indication information can be information on the PCell of the terminal device, which means that when the indication information on the PCell is received by the terminal device, the terminal device can determine, according to the indication information, not to receive at least one of the following on the one or more serving cells: the SSB, the CSI-RS, or the SPS-PDSCH, or not to receive at least one of the following on the one or more serving cell sets: the SSB, the CSI-RS, or the SPS-PDSCH. In this way, signaling overhead can be reduced, flexibility can be improved, and the energy consumption of the terminal device can be reduced.

Optionally, for any one of the first possible implementation and the second possible implementation, the indication information can be implemented in any one of the following manners.

In manner A, the indication information can contain one or more bits, and any mode corresponding to the one or more bits is determined based on a field in a higher-layer signaling. In other words, any mode corresponding to the one or more bits is determined based on a higher-layer parameter. It can be noted that the higher-layer signaling is sent by the network device.

For example, the indication information contains 1 bit, and two modes corresponding to the 1 bit are determined based on the higher-layer parameter. The two modes corresponding to the 1 bit can be bit 0 and bit 1. One mode (e.g., bit 1) corresponding to the 1 bit can, for example, indicate that the terminal device is to enter the first state during the first time interval, and the other mode (e.g., bit 0) corresponding to the 1 bit can, for example, indicate that the terminal device is not to enter the first state during the first time interval, or vice versa.

For another example, the indication information contains 2 bits, and four modes corresponding to the 2 bits are determined based on the higher-layer parameter. The four modes corresponding to the 2 bits are bit sequence 00, bit sequence 01, bit sequence 10, and bit sequence 11. Different bit sequences indicate different information. For example, one mode (e.g., bit sequence 00) corresponding to the 2 bits can, for example, indicate that the terminal device is not to enter the first state during the first time interval, another mode (e.g., bit sequence 01) corresponding to the 2 bits can, for example, indicate that the terminal device does not receive the SSB during the first time interval, another mode (e.g., bit sequence 10) corresponding to the 2 bits can, for example, indicate that the terminal device does not receive the CSI-RS during the first time interval, and another mode (e.g., bit sequence 11) corresponding to the 2 bits can, for example, indicate the terminal device does not receive the SPS-PDSCH during the first time interval. The above is an example, and there may be other combinations, which are not repeated herein.

For another example, the indication information contains 3 bits, and eight modes corresponding to the 3 bits are determined based on the higher-layer parameter. The eight modes corresponding to the 3 bits are bit sequence 000, bit sequence 001, bit sequence 010, bit sequence 011, bit sequence 100, bit sequence 101, bit sequence 110, and bit sequence 111. Different bit sequences indicate different information. For example, one mode (e.g., bit sequence 000) corresponding to the 3 bits can, for example, indicate that the terminal device is not to enter the first state during the first time interval, another mode (e.g., bit sequence 001) corresponding to the 3 bits can, for example, indicate that the terminal device does not receive the SSB during the first time interval, another mode (e.g., bit sequence 010) corresponding to the 3 bits can, for example, indicate that the terminal device does not receive the CSI-RS during the first time interval, another mode (e.g., bit sequence 011) corresponding to the 3 bits can, for example, indicate the terminal device does not receive the SPS-PDSCH during the first time interval, another mode (e.g., bit sequence 100) corresponding to the 3 bits can, for example, indicate the terminal device does not receive the SSB and the CSI-RS during the first time interval, another mode (e.g., bit sequence 101) corresponding to the 3 bits can, for example, indicate the terminal device does not receive the SSB and the SPS-PDSCH during the first time interval, etc. The above is an example, and there may be other combinations, which are not repeated herein.

In manner B, the indication information can contain one or more bits, a first mode corresponding to the one or more bits indicates that the terminal device is not to enter the first state, and a second mode corresponding to the one or more bits is determined based on the field in the higher-layer signaling. In other words, the second mode corresponding to the one or more bits is determined based on a higher-layer parameter. Optionally, the first mode can be one of modes corresponding to the one or more bits, and the second mode can be a mode other than the first mode among the modes corresponding to the one or more bits.

For example, the indication information contains 1 bit, the first mode is bit 0, the second mode is bit 1, or vice versa. For example, the first mode can, for example, indicate that the terminal device is not to enter the first state during the first time interval, and the second mode can, for example, indicate that the terminal device does not receive one or more of the SSB, the CSI-RS, and the SPS-PDSCH during the first time interval.

For another example, the indication information contains 2 bits, and four modes corresponding to the 2 bits are bit sequence 00, bit sequence 01, bit sequence 10, and bit sequence 11. Different bit sequences indicate different information. For example, the first mode (e.g., bit sequence 00) can, for example, indicate that the terminal device is not to enter the first state during the first time interval. The second mode can include bit sequence 01, bit sequence 10, and bit sequence 11. Specifically, bit sequence 01 can, for example, indicate that the terminal device does not receive the SSB during the first time interval, bit sequence 10 can, for example, indicate that the terminal device does not receive the CSI-RS during the first time interval, and bit sequence 11 can, for example, indicate the terminal device does not receive the SPS-PDSCH during the first time interval. The above is an example, and there may be other combinations, which are not repeated herein.

For another example, the indication information contains 3 bits, and eight modes corresponding to the 3 bits are bit sequence 000, bit sequence 001, bit sequence 010, bit sequence 011, bit sequence 100, bit sequence 101, bit sequence 110, and bit sequence 111. Different bit sequences indicate different information. For example, the first mode (e.g., bit sequence 000) can, for example, indicate that the terminal device is not to enter the first state during the first time interval. The second mode can include bit sequence 001, bit sequence 010, bit sequence 011, bit sequence 100, bit sequence 101, bit sequence 110, and bit sequence 111. Specifically, bit sequence 001 can, for example, indicate that the terminal device does not receive the SSB during the first time interval, bit sequence 010 can, for example, indicate that the terminal device does not receive the CSI-RS during the first time interval, bit sequence 011 can, for example, indicate the terminal device does not receive the SPS-PDSCH during the first time interval, bit sequence 100 can, for example, indicate the terminal device does not receive the SSB and the CSI-RS during the first time interval, bit sequence 101 can, for example, indicate the terminal device does not receive the SSB and the SPS-PDSCH during the first time interval, etc. The above is an example, and there may be other combinations, which are not repeated herein.

In manner C, the indication information contains multiple bits, the multiple bits correspond to one bitmap, and each bit in the bitmap corresponds to a signal or a channel.

For example, the indication information contains 2 bits, the 2 bits correspond to one bitmap, and each bit in the bitmap corresponds to a signal or a channel. One bit in the bitmap can correspond to the SSB, the CSI-RS, or the SPS-PDSCH. For example, the first bit in the bitmap corresponds to the SSB, and the second bit in the bitmap corresponds to the CSI-RS. When both the first bit and the second bit are 0, it means that the network device does not send the SSB and the CSI-RS, or it can also be understood that the terminal device does not receive the SSB and the CSI-RS during the first time interval. The above is an example, and there may be other combinations, which are not repeated herein.

For another example, the indication information contains 3 bits, the 3 bits correspond to one bitmap, and each bit in the bitmap corresponds to a signal or channel. One bit in the bitmap can correspond to the SSB, the CSI-RS, or the SPS-PDSCH. For example, the first bit in the bitmap corresponds to the SSB, the second bit in the bitmap corresponds to the CSI-RS, and the third bit in the bitmap corresponds to the SPS-PDSCH. When all of the first bit, the second bit, and the third bit are 0, it means that the network device does not send the SSB, the CSI-RS, and the SPS-PDSCH, or it can also be understood that the terminal device does not receive the SSB, the CSI-RS, and the SPS-PDSCH during the first time interval. The above is an example, and there may be other combinations, which are not repeated herein.

In manner A to manner C, whether to use the first possible implementation or the second possible implementation can be determined by the terminal device itself, configured by the network device, specified by the protocol, or pre-configured in other manners, which is not limited in the present disclosure.

At step 203, the terminal device determines, according to the indication information, to be in the first state during the first time interval.

As can be seen from the above technical solution, when the network device has no data packet to be sent to the terminal device during the active time, the network device can dynamically enable, through the indication information, the terminal device to be in the first state during the first time interval, i.e., the terminal device does not monitor signals or channels, thereby reducing energy consumption.

Reference can be made to FIG. 3. FIG. 3 is a schematic structural diagram of a communication apparatus provided in embodiments of the present disclosure. The communication apparatus can be a terminal device or a device (e.g., a chip) having the function of the terminal device. Specifically, as illustrated in FIG. 3, the communication apparatus 300 can include a determining unit 301. The determining unit 301 is configured to determine, according to indication information, to be in a first state during a first time interval.

Optionally, the indication information is carried in a DCI format 2_6 or a first DCI format.

Optionally, the indication information is carried in the DCI format 2_6, and the first time interval is an on duration of an onDuration timer.

Optionally, the indication information is carried in the first DCI format, and the first time interval is a preset duration, or the first time interval is a configured duration, or the first time interval is an on duration of a preset timer, or the first time interval is a duration indicated by a parameter of the preset timer.

Optionally, a starting time of the first state is an M-th slot after a first end symbol, where M is an integer greater than or equal to 1, and the first end symbol is a last symbol of a PDCCH. Alternatively, the starting time of the first state is an N-th slot after a second end symbol, where N is an integer greater than or equal to 1, the second end symbol is a K-th symbol after the last symbol of the PDCCH, and K is an integer greater than or equal to 1. The first DCI format is carried in the PDCCH.

Optionally, the communication apparatus 300 further includes an obtaining unit 302. When the indication information is obtained, the obtaining unit 302 is configured to monitor the first DCI format during the on duration of the onDuration timer.

Optionally, a terminal device in the first state skips receiving at least one of the following on one or more serving cells: an SSB, a CSI-RS, or an SPS-PDSCH. Alternatively, the terminal device in the first state skips receiving at least one of the following on one or more serving cell sets: the SSB, the CSI-RS, or the SPS-PDSCH.

Optionally, the indication information contains one or more bits, and any mode corresponding to the one or more bits is determined based on a field in a higher-layer signaling.

Optionally, the indication information contains one or more bits, a first mode corresponding to the one or more bits indicates that the terminal device is not to enter the first state, and a second mode corresponding to the one or more bits is determined based on the field in a higher-layer signaling.

Optionally, the indication information contains multiple bits, the multiple bits correspond to one bitmap, and each bit in the bitmap corresponds to a signal or a channel.

Optionally, the indication information contains 1 bit, 2 bits, or 3 bits.

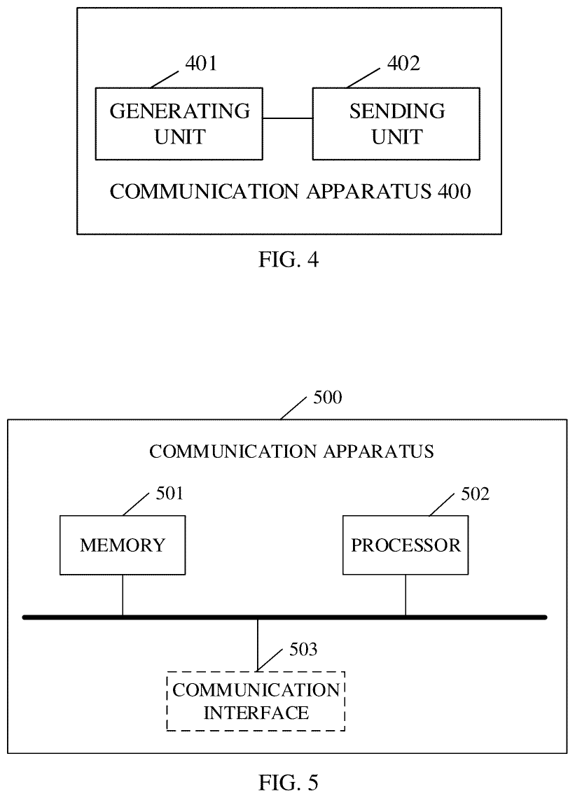

Reference can be made to FIG. 4. FIG. 4 is another schematic structural diagram of a communication apparatus provided in embodiments of the present disclosure. The communication apparatus can be a network device or a device (e.g., a chip) having the function of the network device. Specifically, as illustrated in FIG. 4, the communication apparatus 400 can include a generating unit 401 and a sending unit 402. The generating unit 401 is configured to generate indication information, where the indication information indicates that the terminal device is to be in a first state during a first time interval. The sending unit 402 is configured to send the indication information.

Optionally, the indication information is carried in a DCI format 2_6 or a first DCI format.

Optionally, the indication information is carried in the DCI format 2_6, and the first time interval is an on duration of an onDuration timer.

Optionally, the indication information is carried in the first DCI format, and the first time interval is a preset duration, or the first time interval is a configured duration, or the first time interval is an on duration of a preset timer, or the first time interval is a duration indicated by a parameter of the preset timer.

Optionally, a starting time of the first state is an M-th slot after a first end symbol, where M is an integer greater than or equal to 1, and the first end symbol is a last symbol of a PDCCH. Alternatively, the starting time of the first state is an N-th slot after a second end symbol, where N is an integer greater than or equal to 1, the second end symbol is a K-th symbol after the last symbol of the PDCCH, and K is an integer greater than or equal to 1. The first DCI format is carried in the PDCCH.

Optionally, the indication information contains one or more bits, and any mode corresponding to the one or more bits is determined based on a field in a higher-layer signaling.

Optionally, the indication information contains one or more bits, a first mode corresponding to the one or more bits indicates that the terminal device is not to enter the first state, and a second mode corresponding to the one or more bits is determined based on the field in a higher-layer signaling.

Optionally, the indication information contains multiple bits, the multiple bits correspond to one bitmap, and each bit in the bitmap corresponds to a signal or a channel.

Optionally, the indication information contains 1 bit, 2 bits, or 3 bits.

A chip is further provided in embodiments of the present disclosure. The chip can perform related operations implemented by the terminal device in the method embodiments. The chip includes a processor and a communication interface. In a possible implementation, the processor is configured to cause the chip to perform as follows. Determine to be in a first state during a first time interval according to indication information.

Optionally, the indication information is carried in a DCI format 2_6 or a first DCI format.

Optionally, the indication information is carried in the DCI format 2_6, and the first time interval is an on duration of an onDuration timer.

Optionally, the indication information is carried in the first DCI format, and the first time interval is a preset duration, or the first time interval is a configured duration, or the first time interval is an on duration of a preset timer, or the first time interval is a duration indicated by a parameter of the preset timer.

Optionally, a starting time of the first state is an M-th slot after a first end symbol, where M is an integer greater than or equal to 1, and the first end symbol is a last symbol of a PDCCH. Alternatively, the starting time of the first state is an N-th slot after a second end symbol, where N is an integer greater than or equal to 1, the second end symbol is a K-th symbol after the last symbol of the PDCCH, and K is an integer greater than or equal to 1. The first DCI format is carried in the PDCCH.

Optionally, when the indication information is obtained, the processor is configured to cause the chip to monitor the first DCI format during the on duration of the onDuration timer.

Optionally, a terminal device in the first state skips receiving at least one of the following on one or more serving cells: an SSB, a CSI-RS, or an SPS-PDSCH. Alternatively, the terminal device in the first state skips receiving at least one of the following on one or more serving cell sets: the SSB, the CSI-RS, or the SPS-PDSCH.

Optionally, the indication information contains one or more bits, and any mode corresponding to the one or more bits is determined based on a field in a higher-layer signaling.

Optionally, the indication information contains one or more bits, a first mode corresponding to the one or more bits indicates that the terminal device is not to enter the first state, and a second mode corresponding to the one or more bits is determined based on the field in a higher-layer signaling.

Optionally, the indication information contains multiple bits, the multiple bits correspond to one bitmap, and each bit in the bitmap corresponds to a signal or a channel.

Optionally, the indication information contains 1 bit, 2 bits, or 3 bits.

A chip is further provided in embodiments of the present disclosure. The chip can perform related operations implemented by the network device in the method embodiments. The chip includes a processor and a communication interface. In a possible implementation, the processor is configured to cause the chip to perform as follows. Indication information is generated, where the indication information indicates that the terminal device is to be in a first state during a first time interval. The indication information is sent.

Optionally, the indication information is carried in a DCI format 2_6 or a first DCI format.

Optionally, the indication information is carried in the DCI format 2_6, and the first time interval is an on duration of an onDuration timer.

Optionally, the indication information is carried in the first DCI format, and the first time interval is a preset duration, or the first time interval is a configured duration, or the first time interval is an on duration of a preset timer, or the first time interval is a duration indicated by a parameter of the preset timer.

Optionally, a starting time of the first state is an M-th slot after a first end symbol, where M is an integer greater than or equal to 1, and the first end symbol is a last symbol of a PDCCH. Alternatively, the starting time of the first state is an N-th slot after a second end symbol, where N is an integer greater than or equal to 1, the second end symbol is a K-th symbol after the last symbol of the PDCCH, and K is an integer greater than or equal to 1. The first DCI format is carried in the PDCCH.

Optionally, the indication information contains one or more bits, and any mode corresponding to the one or more bits is determined based on a field in a higher-layer signaling.

Optionally, the indication information contains one or more bits, a first mode corresponding to the one or more bits indicates that the terminal device is not to enter the first state, and a second mode corresponding to the one or more bits is determined based on the field in a higher-layer signaling.

Optionally, the indication information contains multiple bits, the multiple bits correspond to one bitmap, and each bit in the bitmap corresponds to a signal or a channel.

Optionally, the indication information contains 1 bit, 2 bits, or 3 bits.

In a possible implementation, the chip includes at least one processor, at least one first memory, and at least one second memory. The at least one first memory and the at least one processor are connected to each other via a line, and the first memory is configured to store instruction. The at least one second memory and the at least one processor are connected to each other via a line, and the second memory is configured to store data to be stored in the method embodiments.

For various devices and products applicable to or integrated into the chip, various modules included therein may all be implemented by means of hardware such as circuits. Alternatively, at least some of the modules may be implemented by means of a software program executed on a processor integrated into the chip, and the rest (if any) of the modules may be implemented by means of hardware such as a circuit.

Referring to FIG. 5, FIG. 5 is yet another schematic structural diagram of a communication apparatus provided in embodiments of the present disclosure. The communication apparatus can be a terminal device or a network device. The communication apparatus 500 can include a memory 501 and a processor 502. Optionally, the communication apparatus 500 further includes a communication interface 503. The memory 501, the processor 502, and the communication interface 503 are connected to one another via one or more communication buses. The communication interface 503 is controlled by the processor 502 for transmitting and receiving information.

The memory 501 can include a read-only memory (ROM) and a random access memory (RAM) and provide instructions and data to the processor 502. A portion of the memory 501 can also include a non-volatile RAM.

The communication interface 503 is configured to receive or transmit data.

The processor 502 can be a central processing unit (CPU), other general-purpose processors, a digital signal processor (DSP), an application-specific integrated circuit (ASIC), field-programmable gate array (FPGA), other programmable logic devices, discrete gates or transistor logic devices, discrete hardware components, etc. The general-purpose processor can be a microprocessor, and optionally, the processor 502 can also be any conventional processor or the like. The memory 501 is configured to store program instructions. The processor 502 is configured to invoke the program instructions stored in memory 501. The processor 502 is configured to invoke the program instructions stored in the memory 501 to cause the communication apparatus 500 to perform the method implemented by the terminal device or the network device in the method embodiments.

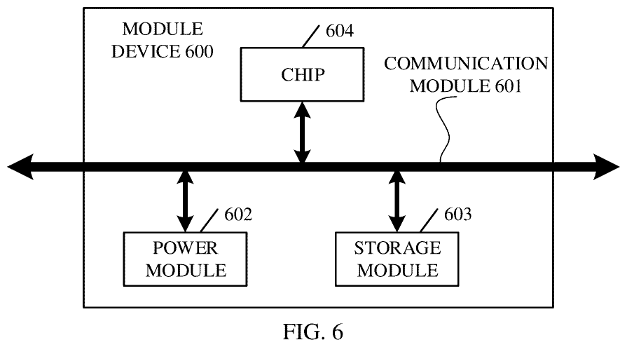

As illustrated in FIG. 6, FIG. 6 is a schematic structural diagram of a module device provided in embodiments of the present disclosure. The module device 600 can perform related operations implemented by the terminal device or the network device in the method embodiments. The module device 600 includes a communication module 601, a power module 602, a storage module 603, and a chip 604.

The power module 602 is configured to power the module device. The storage module 603 is configured to store data and instructions. The communication module 601 is configured to perform internal communication within the module device or perform communication between the module device and an external device. The chip 604 is configured to perform the method implemented by the terminal device or the network device in the method embodiments.

It can be noted that for contents not mentioned and specific embodiments of various operations in embodiments corresponding to FIG. 5 or FIG. 6, reference can be made to embodiments illustrated in FIG. 2 and the foregoing, which is not repeated herein.

A computer-readable storage medium is further provided in embodiments of the present disclosure. The computer-readable storage medium is configured to store instructions which, when executed on a processor, cause the processor to implement the operations of the method in the method embodiments.

A computer program product is further provided in embodiments of the present disclosure. When the computer program product is executed on a processor, the processor can implement the operations of the method in the method embodiments.

For each apparatus and product described in the embodiments, each module/unit included can be a software module/unit, a hardware module/unit, or can be partially a software module/unit and partially a hardware module/unit. For example, for each apparatus and product applied to or integrated into the chip, each module/unit included can be implemented by hardware such as circuits, or at least part of modules/units can be implemented by software programs that are executed on a processor integrated into the chip, and the rest (if any) of modules/units can be implemented by hardware such as circuits. For each apparatus and product applied to or integrated into the chip module, each module/unit included can be implemented by hardware such as a circuit, and different modules/units can be located in a same component (such as a chip, a circuit module, etc.) or different components of the chip module. Alternatively, at least part of modules/units can be implemented by software programs that are executed on the processor integrated into the chip module, and the rest (if any) of modules/units can be implemented by hardware such as circuits. For each apparatus and product applied to or integrated into the terminal, each module/unit included can be implemented by hardware such as circuits, and different modules/units can be located in a same component (e.g., a chip, a circuit module, etc.) or different components in the terminal, or at least part of modules/units can be implemented by software programs that executed on the processor integrated into the terminal, and the rest (if any) of modules/units can be implemented by hardware such as circuits.

It can be noted that, for the sake of simplicity, the foregoing method embodiments are described as a series of action combinations. However, it will be appreciated by those skilled in the art that embodiments are not limited by the sequence of actions described. According to embodiments, some steps or operations can be performed in other orders or simultaneously. Besides, it will be appreciated by those skilled in the art that the embodiments described in the specification are exemplary embodiments, and the actions and modules involved are not necessarily essential to the present disclosure.

Mutual reference can be made to the descriptions of various embodiments of the present disclosure, and the description of each embodiment has its own emphasis. For the parts not described in detail in one embodiment, reference can be made to related descriptions in other embodiments. For the sake of convenience and simplicity, for functions of the apparatuses and devices provided in embodiments of the present disclosure and operations performed by the apparatuses and devices, reference can be made to related descriptions of the method embodiments of the present disclosure. The method embodiments and the apparatus embodiments can also be mutually referred to, combined, or cited.

Finally, it can be noted that the foregoing embodiments are merely intended for describing the technical solutions of the present disclosure, but not for limiting the present disclosure. Although the present disclosure is described in detail with reference to the foregoing embodiments, those of ordinary skill in the art can understand that they can still make modifications to the technical solutions described in the foregoing embodiments or make equivalent replacements to some or all technical features thereof, without departing from the scope of the technical solutions of embodiments of the present disclosure.

The present disclosure provides a communication method, a communication apparatus, a chip, and a module device, which can reduce energy consumption.

In a first aspect, a communication method is provided. The communication method includes the following. Determine to be in a first state during a first time interval according to indication information.

As can be seen from the above technical solution, when a network device has no data packet to be sent to a terminal device during an active time, the network device can dynamically enable, through the indication information, the terminal device to be in the first state during the first time interval, i.e., the terminal device does not monitor signals or channels during the first time interval, thereby reducing energy consumption.

Optionally, in conjunction with the first aspect, the indication information is carried in a downlink control information (DCI) format 2_6 or a first DCI format.

As can be seen from the above technical solution, in a possible implementation, the DCI format 2_6 is reused, thereby reducing signaling overhead. In addition, the terminal device needs to receive the DCI format 2_6 for its own energy-saving gain. Since the indication information can be carried in the DCI format 2_6, the terminal device can obtain the indication information without any extra operation, which reduces the complexity of the terminal device and reduces the energy consumption of the terminal device. In another possible implementation, a new DCI format (i.e., the first DCI format) that is different from the DCI format 2_6 can be used, thereby realizing decoupling from the DCI format 2_6. In this way, the network device can save energy by using the first DCI format or the DCI format 2_6, thereby increasing system flexibility.

Optionally, in conjunction with the first aspect, the indication information is carried in the DCI format 2_6, and the first time interval is an on duration of an onDuration timer.

As can be seen from the above technical solution, the terminal device can be in the first state during the on duration of the onDuration timer, i.e., the terminal device does not monitor signals or channels during the on duration of the onDuration timer, thereby reducing energy consumption.

Optionally, in conjunction with the first aspect, the indication information is carried in the first DCI format, and the first time interval is a preset duration, or the first time interval is a configured duration, or the first time interval is an on duration of a preset timer, or the first time interval is a duration indicated by a parameter of the preset timer.

As can be seen from the above technical solution, decoupling from the on duration of the onDuration timer is realized, thereby improving the system flexibility. Meanwhile, the signaling overhead can be reduced through the preset duration, the on duration of the preset timer, or the duration indicated by the parameter of the preset timer. In addition, one duration is configured, and the duration can be a time that meets current service requirements, thereby improving the system flexibility.

Optionally, in conjunction with the first aspect, a starting time of the first state is an M-th slot after a first end symbol, where M is an integer greater than or equal to 1, and the first end symbol is a last symbol of a physical downlink control channel (PDCCH). Alternatively, the starting time of the first state is an N-th slot after a second end symbol, where N is an integer greater than or equal to 1, the second end symbol is a K-th symbol after the last symbol of the PDCCH, and K is an integer greater than or equal to 1. The first DCI format is carried in the PDCCH.

As can be seen from the above technical solution, since the starting time of the first state is the M-th slot after the first end symbol or the N-th slot after the second end symbol, after the terminal device knows, through the PDCCH, that no synchronization signal and physical broadcast channel block (SSB), channel state information-reference signal (CSI-RS), or semi-persistent-physical downlink shared channel (SPS-PDSCH) has been sent, the terminal device can cancel reception of the SSB, the CSI-RS, the SPS-PDSCH, etc., thereby reducing the energy consumption. Secondly, it can also be seen that the starting time of the first state is not a time when the PDCCH is received by the terminal device. As such, the terminal device can have more time to receive the PDCCH, and the network device can have more time to prepare for the transmission of the PDCCH.

Optionally, in conjunction with the first aspect, the indication information is obtained as follows. The first DCI format is monitored during the on duration of the onDuration timer.

As can be seen from the above technical solution, the terminal device monitors the first DCI format during the on duration of the onDuration timer, so that the terminal device can determine, according to the indication information, to be in the first state during the first time interval, which means that the terminal device has known that the network device has no data packet to be sent to the terminal device during the active time, and that the terminal device is not required to monitor the CSI-RS, the SSB, a tracking reference signal (TRS), the SPS-PDSCH, etc., during the first time interval, thereby reducing the energy consumption.

Optionally, in conjunction with the first aspect, a terminal device in the first state skips receiving at least one of the following on one or more serving cells: the SSB, the CSI-RS, or the SPS-PDSCH. Alternatively, the terminal device in the first state skips receiving at least one of the following on one or more serving cell sets: the SSB, the CSI-RS, or the SPS-PDSCH.

As can be seen from the above technical solution, since the terminal device in the first state does not receive at least one of the following on the one or more serving cells: the SSB, the CSI-RS, or the SPS-PDSCH, or the terminal device in the first state does not receive at least one of the following on the one or more serving cell sets: the SSB, the CSI-RS, or the SPS-PDSCH, the energy consumption of the terminal device can be reduced.

Optionally, in conjunction with the first aspect, the indication information contains one or more bits, and any mode corresponding to the one or more bits is determined based on a field in a higher-layer signaling.

As can be seen from the above technical solution, any mode corresponding to the one or more bits is determined based on the field in the higher-layer signaling, which means that whether to enter the first state can be configured by the network device through a higher-layer parameter. For example, the network device can combine not receiving or receiving one or more of the SSB, the CSI-RS, the SPS-PDSCH, etc., into different modes, thereby improving the flexibility.

Optionally, in conjunction with the first aspect, the indication information contains one or more bits, a first mode corresponding to the one or more bits indicates that the terminal device is not to enter the first state, and a second mode corresponding to the one or more bits is determined based on a field in a higher-layer signaling.

As can be seen from the above technical solution, one mode is determined as not to enter the first state, and other modes can be configured by the network device through a higher-layer parameter. For example, the network device can combine not receiving the SSB, not receiving the CSI-RS, not receiving the SPS-PDSCH, etc., into one mode, instead of adopting three modes to respectively indicate not receiving the SSB, not receiving the CSI-RS, and not receiving the SPS-PDSCH. As such, two signaling overheads can be reduced, and the flexibility can be improved.

Optionally, in conjunction with the first aspect, the indication information contains multiple bits, the multiple bits correspond to one bitmap, and each bit in the bitmap corresponds to a signal or a channel.

Optionally, in conjunction with the first aspect, the indication information contains 1 bit, 2 bits, or 3 bits.

In a second aspect, a communication method is provided. The communication method includes the following. Indication information is generated, where the indication information indicates that a terminal device is to be in a first state during a first time interval. The indication information is sent.

Optionally, in conjunction with the second aspect, the indication information is carried in a DCI format 2_6 or a first DCI format.

Optionally, in conjunction with the second aspect, the indication information is carried in the DCI format 2_6, and the first time interval is an on duration of an onDuration timer.

Optionally, in conjunction with the second aspect, the indication information is carried in the first DCI format, and the first time interval is a preset duration, the first time interval is a configured duration, the first time interval is an on duration of a preset timer, or the first time interval is a duration indicated by a parameter of the preset timer.

Optionally, in combination with the second aspect, a starting time of the first state is an M-th slot after a first end symbol, where M is an integer greater than or equal to 1, and the first end symbol is a last symbol of a PDCCH. Alternatively, the starting time of the first state is an N-th slot after a second end symbol, where N is an integer greater than or equal to 1, the second end symbol is a K-th symbol after the last symbol of the PDCCH, and K is an integer greater than or equal to 1. The first DCI format is carried in the PDCCH.

Optionally, in conjunction with the second aspect, the indication information contains one or more bits, and any mode corresponding to the one or more bits is determined based on a field in a higher-layer signaling.

Optionally, in conjunction with the second aspect, the indication information contains one or more bits, a first mode corresponding to the one or more bits indicates that the terminal device is not to enter the first state, and a second mode corresponding to the one or more bits is determined based on the field in the higher-layer signaling.

Optionally, in conjunction with the second aspect, the indication information contains multiple bits, the multiple bits correspond to one bitmap, and each bit in the bitmap corresponds to a signal or a channel.

Optionally, in conjunction with the second aspect, the indication information contains 1 bit, 2 bits, or 3 bits.

In a third aspect, a communication apparatus is provided. The communication apparatus includes a unit configured to perform the method of any one of the first aspect, or a unit configured to perform the method of any one of the second aspect.

In a fourth aspect, a chip is provided. The chip includes a processor and a communication interface. The processor is configured to cause the chip to perform the method of any one of the first aspect or perform the method of any one of the second aspect.

In a fifth aspect, a module device is provided. The module device includes a communication module, a power module, a storage module, and a chip. The power module is configured to power the module device. The storage module is configured to store data and instructions. The communication module is configured to perform internal communication within the module device or perform communication between the module device and an external device. The chip is configured to perform the method of any one of the first aspect or perform the method of any one of the second aspect.

In a sixth aspect, a communication apparatus is provided. The communication apparatus includes a memory and a processor. The memory is configured to store a computer program, and the computer program includes program instructions. The processor is configured to invoke the program instructions to cause the communication apparatus to perform the method of any one of the first aspect or perform the method of any one of the second aspect.

In a seventh aspect, a computer-readable storage medium is provided. The computer-readable storage medium is configured to store computer-readable instructions which, when executed on a computer, cause the computer to perform the method of any one of the first aspect or perform the method of any one of the second aspect.

In an eighth aspect, a computer program product is provided. The computer program product is configured to store computer-readable instructions which, when executed on a computer, cause the computer to perform the method of any one of the first aspect or perform the method of any one of the second aspect.

In a ninth aspect, a communication system is provided. The communication system includes a terminal device configured to perform the method of any one of the first aspect. The communication system can further include a network device configured to perform the method of any one of the second aspect.

1. A communication method, comprising:
determining, according to indication information, to be in a first state during a first time interval.

2. The method of claim 1, wherein the indication information is carried in a downlink control information (DCI) format 2_6 or a first DCI format.

3. The method of claim 1, wherein the indication information is carried in a DCI format 2_6, and the first time interval is an on duration of an onDuration timer.

4. The method of claim 1, wherein the indication information is carried in a first DCI format, and
the first time interval is a preset duration; or
the first time interval is a configured duration; or
the first time interval is an on duration of a preset timer; or
the first time interval is a duration indicated by a parameter of the preset timer.

5. The method of claim 1, wherein
a starting time of the first state is an M-th slot after a first end symbol, wherein M is an integer greater than or equal to 1, and the first end symbol is a last symbol of a physical downlink control channel (PDCCH); or
the starting time of the first state is an N-th slot after a second end symbol, wherein N is an integer greater than or equal to 1, the second end symbol is a K-th symbol after the last symbol of the PDCCH, and K is an integer greater than or equal to 1; wherein
a first DCI format is carried in the PDCCH.

6. The method of claim 1, wherein obtaining the indication information comprises:
monitoring a first DCI format during an on duration of an onDuration timer.

7. The method of claim 1, wherein
a terminal device in the first state skips receiving at least one of the following on one or more serving cells: a synchronization signal and physical broadcast channel block (SSB), a channel state information-reference signal (CSI-RS), or a semi-persistent-physical downlink shared channel (SPS-PDSCH); or
the terminal device in the first state skips receiving at least one of the following on one or more serving cell sets: an SSB, a CSI-RS, or an SPS-PDSCH.

8. The method of claim 1, wherein the indication information contains one or more bits, and any mode corresponding to the one or more bits is determined based on a field in a higher-layer signaling.

9. The method of claim 1, wherein the indication information contains one or more bits, a first mode corresponding to the one or more bits indicates that the terminal device is not to enter the first state, and a second mode corresponding to the one or more bits is determined based on a field in a higher-layer signaling.

10. The method of claim 1, wherein the indication information contains a plurality of bits, the plurality of bits correspond to one bitmap, and each bit in the bitmap corresponds to a signal or a channel.

11. (canceled)

12. A communication method, comprising:
generating indication information, wherein the indication information indicates that a terminal device is to be in a first state during a first time interval; and
sending the indication information.

13. The method of claim 12, wherein the indication information is carried in a downlink control information (DCI) format 2_6 or a first DCI format.

14. The method of claim 12, wherein the indication information is carried in a DCI format 2_6, and the first time interval is an on duration of an onDuration timer.

15. The method of claim 12, wherein the indication information is carried in a first DCI format, and
the first time interval is a preset duration; or
the first time interval is a configured duration; or
the first time interval is an on duration of a preset timer; or
the first time interval is a duration indicated by a parameter of the preset timer.

16. The method of claim 12, wherein
a starting time of the first state is an M-th slot after a first end symbol, wherein M is an integer greater than or equal to 1, and the first end symbol is a last symbol of a physical downlink control channel (PDCCH); or
the starting time of the first state is an N-th slot after a second end symbol, wherein N is an integer greater than or equal to 1, the second end symbol is a K-th symbol after the last symbol of the PDCCH, and K is an integer greater than or equal to 1; wherein
a first DCI format is carried in the PDCCH.

17. The method of claim 12, wherein the indication information contains one or more bits, and any mode corresponding to the one or more bits is determined based on a field in a higher-layer signaling.

18. The method of claim 12, wherein the indication information contains one or more bits, a first mode corresponding to the one or more bits indicates that the terminal device is not to enter the first state, and a second mode corresponding to the one or more bits is determined based on a field in a higher-layer signaling.

19. The method of claim 12, wherein the indication information contains a plurality of bits, the plurality of bits correspond to one bitmap, and each bit in the bitmap corresponds to a signal or a channel.

20-21. (canceled)

22. A chip, comprising:
a communication interface; and
a processor configured to cause the chip to:
determine, according to indication information, to be in a first state during a first time interval.

23-25. (canceled)
